(19) United States
(12) Patent Application Publication
(10) Pub. No.: US 2026/0061386 A1
(43) Pub. Date: Mar. 5, 2026

(54) SWIRL REACTOR

(71) Applicant: KATHOLIEKE UNIVERSITEIT LEUVEN, Leuven (BE)

(72) Inventors: Thomas HOLEMANS, Leuven (BE); Bert LAGRAIN, Leuven (BE); Bert SELS, Westerlo (BE); Joost VAN AELST, Diepenbeek (BE); Sander VAN DEN BOSCH, Boortmeerbeek (BE); Maarten VANIERSCHOT, Heverlee (BE); Zhu YANG, Sichuan (CN)

(21) Appl. No.: 19/106,841

(22) PCT Filed: Aug. 30, 2023
(86) PCT No.: PCT/EP2023/073825

§ 371 Date: Feb. 26, 2025

(30) Foreign Application Priority Data
Aug. 30, 2022 (EP) 22192980.5
Jul. 6, 2023 (EP) 23183803.8

(51) Int. Cl. B01J 8/22; B01J 4/00

(52) U.S. Cl. CPC B01J 8/226; B01J 4/002; B01J 2208/00902

(57) ABSTRACT

A continuous flow reactor includes a swirl flow generator and a mixing vessel including (i) a lower cylindrical part in direct fluid communication with the outlet of the swirl generator; (ii) an upper cylindrical part of diameter larger than the diameter of the lower cylindrical part; (iii) a tapered part located between the lower cylindrical part and the upper cylindrical part; and, (iv) an outlet located on the upper base of the upper cylindrical part and outside of the central part of said upper base. A swirl number that the swirl generator is adapted to provide, and the dimensions of the mixing vessel, are adapted to generate a Coanda flow of liquid, such as an upward Coanda flow of liquid, along the wall of the tapered part and the wall of the upper cylindrical part, when liquid is flowing through the reactor.

### FIELD OF THE INVENTION

The present invention relates to a continuous flow chemical reactor and to a method for mixing reagents, in particular liquid-solid mixtures, therewith.

### BACKGROUND OF THE INVENTION

The vast majority of applications of mixing techniques (i.e. about 80%) requires the mixing of solid particles with a liquid, i.e. solid-liquid mixing. It is one of the most energy-consuming steps in many production processes, and if mixing is insufficient the yield and selectivity of these processes are limited.

One of the most widely used mixing systems is the mechanically agitated vessel, which is shaft-driven or magnetically coupled. More than 50% of the world's production of chemicals involve these type of vessels. The mechanically agitated vessel has proven useful over the years but still has several shortcomings. These shortcomings have driven plenty of intensification studies on this subject and a steady stream of technological improvements. The 307 publications, stated in Jaszczur et al., (“A General Review of the Current Development of Mechanically Agitated Vessels. Processes 2020, 8 (8), 982), show the urge for a further improvement of the current state-of-the-art. According to this review, the main shortcomings of mechanically agitated vessels comprise the following:
Only small-scale stirred vessels can operate at high-pressure (>2 MPa) because of sealing problems at the connection between the motor and the impeller rod and insufficient magnetic torque to stir larger quantities of (viscous) mass.
Mechanical stirring requires a high power input to obtain sufficient mixing, especially for high-viscosity substances.
Some types of solids (e.g. mammalian cells in bioreactors) are shear sensitive, for which the rotational speed of the impeller has to be limited to very low values.
In certain cases, the maximum rotation of the impeller is limited because of gas entrainment, resulting in non-optimal mixing characteristics and lower yields.
In the case of a vessel serving as a multiphase reactor, significant variation of the concentration of reagents/solvents/catalysts throughout the vessel also leads to significant variation in local reaction rates and, ultimately, also to a lower yield of desired product, a loss of selectivity and overconsumption of catalyst.
Redundancy is only possible with a complete parallel set-up (vessel, impeller and motor).

These shortcomings show that a new mixing technology would have a high application potential in the chemical industry. A specific application for a new mixing technology is Reductive Catalytic Fractionation of lignocellulose, abbreviated as RCF. It has rapidly emerged in the past couple of years. It fractionates lignocellulose, a sustainable and highly abundant source of biomass and renewable carbon, into different product streams, amenable to further valorization. At present, lab-scale experiments show encouraging results demonstrating the potential for this technology on a large scale and economically viable industrial production. As RCF biorefinery ingredients include biomass, solvent and catalyst, the mixing system needs to consolidate the work in solid-liquid conditions to form a homogeneous solid-liquid suspension, avoiding the settling of solids at the bottom and ensuring a uniform distribution that increases the interaction surface between the solid and liquid. However, no current solid-liquid mixing technology is sufficient for industrial RCF-based lignocellulose production. The mainstream shaft-driven stirring technology cannot be used in industrial-sized reactors due to sealing problems under high temperature and pressure conditions, and magnetically coupled stirring technology cannot be applied due to high particle concentrations. Thus, a new mixing technology is necessary.

Recent research has shown that swirl flow effectively enhances the mixing in both turbulent combustion systems and laminar microscale reactors (Ogus et al., Numerical Investigation of a Novel Microscale Swirling Jet Reactor for Medical Sensor Applications, Journal of Physics. Conference Series, vol. 980, no. 1, 2018, p. 12030) but no implementation of swirl in continuous flow reactors for mixing solid particles with a liquid in an energy-efficient manner, amenable to simple high-pressure reactor design, and suitable for use with shear-sensitive solids, is available.

### SUMMARY

The present invention relates to a continuous flow reactor comprising:
an inlet;
a swirl generator, downstream of, and in fluid communication with, the inlet; and,
a mixing vessel, comprising, preferably wherein the wall of the mixing vessel defines,
   (i) a lower cylindrical part in fluid communication, preferably in direct fluid communication, with the outlet of the swirl generator;
   (ii) an upper cylindrical part of a diameter larger than the diameter of the lower cylindrical part;
   (iii) a tapered part located between the lower cylindrical part and the upper cylindrical part, wherein the wall of the tapered part forms an angle α, measured inside the mixing vessel, with the wall of the upper cylindrical part superior to 90 degrees and inferior to 180 degrees; and,
   (iv) an outlet located on an upper base of the upper cylindrical part and outside of a central part of said upper base, wherein said central part is a circle, concentric with the upper base, and with a radius of at least 25%, e.g. 25%, of the radius of the upper base.

In one embodiment, a swirl number that the swirl generator is adapted to provide, and the dimensions of the mixing vessel, are adapted, i.e., configured, to generate a Coanda flow of liquid, preferably an upward Coanda flow of liquid, along the wall of the tapered part and the wall of the upper cylindrical part, when liquid is flowing through the reactor. In embodiments, the swirl generator and the dimensions of the mixing vessel are configured to generate a Coanda flow of liquid, preferably an upward Coanda flow of liquid, along the wall of the tapered part and the wall of the upper cylindrical part, when liquid is flowing through the reactor.

In one embodiment, the mixing vessel, preferably the wall of the mixing vessel, further comprises, e.g., the wall of the mixing vessel defines, between the lower cylindrical part and the tapered part, a nozzle comprising a first nozzle part, wherein the angle β, measured outside of the mixing vessel, between the wall of the lower cylindrical part and the wall of the first nozzle part is superior or equal to 90 degrees and inferior to 180 degrees.

In one embodiment, the projected width, e.g. the horizontally projected width, of the first nozzle part is equal to or larger than 1% and inferior or equal to 79% of the diameter of the lower cylindrical part.

In one embodiment, the nozzle further comprises a second nozzle part between the first nozzle part and the tapered part, wherein the angle 7 between the wall of the second nozzle part and the vertical axis of the mixing vessel is superior or equal to 0 degrees and inferior or equal to 90 degrees.

In one embodiment, the projected height, e.g. the vertically projected height, of the second nozzle part is equal to or larger than 1% and inferior to 85% of the diameter of the lower cylindrical part.

In one embodiment, the outlet is located along the edge of the upper base.

In one embodiment, the outlet is an annular outlet concentric with the upper base.

In one embodiment, the outlet comprises a filter.

In one embodiment, the continuous flow reactor is for mixing solid particles in a liquid.

In one embodiment, the angle α is superior or equal to 95 degrees.

In one embodiment, the swirl generator is configured to generate a swirling flow of liquid in the lower cylindrical part.

In one embodiment, the central part is a circle, concentric with the upper base, and with a radius of between 25% and 67%, e.g. 40%, 45% 50%, 55%, 60% or 67%, of the radius of the upper base.

In one embodiment, the mixing vessel further comprises a central draft tube, configured to separate the central downward flow of liquid form the outer upward flow of liquid when liquid is flowing through the reactor.

In one embodiment, the dimensions of the mixing vessel are configured to generate a Coanda flow of liquid along the wall of the tapered part and the wall of the upper cylindrical part.

In one embodiment, the diameter of the upper cylindrical part ranges from 270% to 670% of the diameter of the lower cylindrical part.

In one embodiment, the length of the upper cylindrical part is superior or equal to 50% of the diameter of the lower cylindrical part, and is inferior or equal to 2200% of the diameter of the lower cylindrical part.

The present invention also relates to using the continuous-flow reactor according to the invention for mixing and/or reacting solid particles with a liquid.

### BRIEF DESCRIPTION OF THE DRAWINGS

FIG. 1, including FIGS. 1A and 1B, consists of two drawings of the continuous flow reactor. FIG. 1 illustrates the geometry with the lower cylindrical part [103] and the tapered part [105]. FIG. 1A, is a panel side view; the grid-filled area indicates the filter [108] and the dashed area indicate the swirl generator [101]. FIG. 1B is a top view; dashed area indicates the filter [108].

FIG. 2, including FIGS. 2A and 2B, consists of two drawings of the lower part of the continuous flow reactor (the part above the break line being identical to that of FIG. 1). FIG. 2a illustrates the geometry with the lower cylindrical part [103], the tapered part [105] and a nozzle [200] consisting of one nozzle part [201]. FIG. 2b illustrates the geometry with the lower cylindrical part [103], the tapered part [105] and a nozzle [200] consisting of the first nozzle part [201] and the second nozzle part [202]. The dashed area indicates the swirl generator [101].

FIG. 3, including FIGS. 3A to 3C, consists of three drawings of the lower part of the continuous flow reactor (the part above the break line being identical to that of FIG. 1). 3a, 3b and 3c illustrate the flow structure of the mixing vessel [102] as shown in FIG. 11 with the swirl number Sw=0.5, 1.0 and 1.2, respectively. These drawings are illustrating the flow structure by showing the streamlines in a cross-section of the mixing vessel [102]. References to individual elements of the mixing vessel are identical to that in FIG. 11.

FIG. 4, including FIGS. 4A to 4f, consists of six drawings. FIGS. 4a, 4b and 4c illustrate the utilization of volume of the mixing vessel [102] as shown in FIG. 1, with the length [l104] of the upper cylindrical part [104] being 500 mm, 300 mm, and 100 mm, respectively. These drawings are illustrating the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 4d, 4e and 4f illustrate the flow structure of the mixing vessel [102] as shown in FIG. 1, with the length [l104] of the upper cylindrical part [104] are 500 mm, 300 mm, and 100 mm, respectively. These drawings illustrate the flow structure by showing the streamlines in a cross-section of the mixing vessel [102]. References to individual elements of the mixing vessel are identical to that in FIG. 1.

FIG. 5, including FIGS. 5A to 5D, consists of four drawings. FIGS. 5a and 5b illustrate the utilization of volume of the mixing vessel [102] as shown in FIG. 1 with the diameter [d104] of the upper cylindrical part [104] are 60 mm, 150 mm, respectively. These drawings illustrate the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 5c and 5d illustrate the flow structure of the mixing vessel [102] as shown in FIG. 1 with the diameter [d104] of the upper cylindrical part [104] are 60 mm, 150 mm, respectively. These drawings illustrate the flow structure by showing the streamlines in a cross-section of the mixing vessel [102]. References to individual elements of the mixing vessel are identical to that in FIG. 1.

FIG. 6, including FIGS. 6A to 6D, consists of four drawings. FIGS. 6a and 6b illustrate the utilization of volume of the mixing vessel [102] as shown in FIG. 1 with the diameter [d104] of the upper cylindrical part [104] are 90 mm, 130 mm, respectively. These drawings illustrate the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 6c and 6d illustrate the flow structure of the mixing vessel [102] as shown in FIG. 1 with the diameter [d104] of the upper cylindrical part [104] are 90 mm, 130 mm, respectively. These drawings are illustrating the flow structure by showing the streamlines in a cross-section of the mixing vessel [102]. References to individual elements of the mixing vessel are identical to that in FIG. 1.

FIG. 7, including FIGS. 7A to 7D, consists of four drawings. FIGS. 7a and 7b illustrate the utilization of volume of the mixing vessel [102] with the outlet [106] covering the entire surface of the upper base [107] and an annular outlet as shown in FIG. 1, respectively. These drawings illustrate the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 7c and 7d illustrate the flow structure of the mixing vessel [102] with the outlet [106] covering the entire surface of the upper base [107] and annular outlet as shown in FIG. 1, respectively. These drawings are illustrating the flow structure by showing the steam lines in a cross-section of the mixing vessel [102]. References to individual elements of the mixing vessel are identical to that in FIG. 1.

FIG. 8, including FIGS. 8A to 8F, consists of six drawings. FIGS. 8a, 8b and 8c illustrate the utilization of volume of the mixing vessel [102] as shown in FIG. 1 with angle α being 90 degrees, 165 degrees, 95 degrees, respectively. These drawings are illustrating the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 8d, 8e and 8f illustrate the flow structure of the mixing vessel [102] as shown in FIG. 1 with angle α being 90 degrees, 165 degrees, 95 degrees, respectively. These drawings are illustrating the flow structure by showing the streamlines in a cross-section of the mixing vessel [102]. References to individual elements of the mixing vessel are identical to that in FIG. 1.

FIG. 9, including FIGS. 9A to 9D, consists of four drawings. FIGS. 9a and 9b illustrate the utilization of volume of the mixing vessel [102] as shown in in FIG. 2a with a projected width [w201] of the first nozzle part [201] of 15 mm-0.67 times the diameter [d103] of the lower cylindrical part [103]- and the angle α being 165 degrees and 95 degrees, respectively. These drawings are illustrating the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 9c and 9d illustrate the flow structure of the mixing vessel [102], as shown in FIG. 2a with a projected width [w201] of the first nozzle part [201] of 15 mm-0.67 times the diameter [d103] of the lower cylindrical part [103]- and the angle α being 165 degrees and 95 degrees, respectively. These drawings illustrate the flow structure by showing the streamlines in a cross-section of the mixing vessel [102]. References to individual elements of the mixing vessel are identical to that in FIGS. 1 and 2a.

FIG. 10, including FIGS. 10A to 10D, consists of four drawings. FIGS. 10a and 10b illustrate the utilization of volume of the mixing vessel [102] as shown in in FIG. 2b with a projected height [h202] of the second nozzle part [202] of 20 mm—0.89 times the diameter [d103] of the lower cylindrical part [103]—and the projected width [w201] of the first nozzle part [201] of 18 mm—0.8 times the diameter [d103] of the lower cylindrical part [103], and a projected height [h202] of the second nozzle part [202] is 10 mm—0.44 times the diameter [d103] of the lower cylindrical part [103]—and the projected width [w201] of the first nozzle part [201] of 15 mm—0.67 times the diameter [d103] of the lower cylindrical part [103], respectively. These drawings are illustrating the utilization of volume by showing a time-averaged particle volume concentration in a cross-section of the mixing vessel [102]. The grid-filled area shows the area of particle accumulation at concentrations greater than 30 vol %. The dashed area shows the area of particle accumulation at concentrations lower than 10 vol %. The remaining white area shows the area of particle accumulation at concentrations ranging from 10 vol % to 30 vol %. FIGS. 10c and 10d illustrate the flow structure of the mixing vessel [102] as shown in FIG. 2b with a projected height [h202] of the second nozzle part [202] of 20 mm-0.89 times the diameter [d103] of the lower cylindrical part [103]- and the projected width [w201] of the first nozzle part [201] of 18 mm-0.8 times the diameter [d103] of the lower cylindrical part [103], and a projected height [h202] of the second nozzle part [202] is 10 mm-0.44 times the diameter [d103] of the lower cylindrical part [103]- and the projected width [w201] of the first nozzle part [201] of 15 mm-0.67 times the diameter [d103] of the lower cylindrical part [103], respectively. These drawings are illustrating the flow structure by showing the streamlines in a cross-section of the mixing vessel [102]. References to individual elements of the mixing vessel are identical to that in FIGS. 1 and 2b.

FIG. 11 is a drawing of the continuous reactor illustrating the geometry with the lower cylindrical part [103] and the tapered part [105] and a nozzle [200] consisting of the first nozzle part [201] and the second nozzle part [202]. The grid-filled area indicates the filter [108], and the dashed area indicates the swirl generator [101].

FIG. 12, including FIGS. 12A and 12B, consists of two drawings. FIG. 12a is a drawing showing the streamlines in a cross-section of the mixing vessel [102] of the continuous flow reactor shown in FIG. 11. FIG. 12b is a drawing illustrating the steps of particles movement (thin line) within the mixing vessel [102] in a cross-section of the mixing vessel [102]. The thick line in the lower cylindrical part [103] illustrates the swirl flow. The crossed area indicates the swirl generator [101]. References to individual elements of the mixing vessel is identical to that in FIG. 11.

FIG. 13 is a drawing illustrating the localization of the area with high particle concentration in a cross-section of the mixing vessel [102] of the continuous flow reactor shown in FIG. 11. The black area shows the area of particle accumulation at concentrations greater than 40 vol %. References to individual elements of the continuous flow reactor are identical to that in FIG. 11.

FIG. 14 is a drawing illustrating the utilization of volume by showing a time-averaged particle concentration in a cross-section of the mixing vessel [102] of the continuous flow reactor shown in FIG. 11. The grid-filled area shows the area of particle accumulation at concentrations greater than 25 vol %. The dashed area shows the area of particle accumulation at concentrations lower than 15 vol %. The remaining white area shows the area of particle accumulation at concentrations ranging from 15 vol % to 25 vol %. Solid arrows illustrate liquid displacement in and out of the mixing vessel. References to individual elements of the continuous flow reactor are identical to that in FIG. 11.

FIG. 15 is a graph showing the transient homogeneity in the mixing vessel [102] of the continuous flow reactor shown in FIG. 11.

FIG. 16, including FIGS. 16A and 16B, consists of two drawings of an example of the continuous flow reactor with draft tube. FIG. 16A side view; the grid-filled area indicates the filter [108], the fine dashed areas indicate the supports for the draft tube, and the coarse dashed area indicates the swirl generator [101]; FIG. 16B top view (without the upper base [107]); the slash-filled area indicate the support for the draft tube [301].

### DETAILED DESCRIPTION

Here the inventors have developed a new swirling flow continuous-flow reactor which is based on the flowthrough reactor idea. A Computational Fluid Dynamic (CFD) model was established to predict mixtures' concentration distribution and flow dynamics in the reactor mixing vessel, thereby developing a continuous-flow reactor achieving uniform mixing. The volume of the mixing vessel with a homogeneous suspension occupies more than 96% of the volume of the mixing vessel. Moreover, this new mixing technology achieves 97% homogeneity based on the volume concentration. Besides, the simulation results show the fluid flow structures and the recirculation of particles in the mixing vessel, demonstrating the dominant operating mechanism of swirling flow mixing technology.

The present invention hence relates to a continuous-flow reactor.

The term “continuous flow reactor” is used herein in reference to a continuous reactor (or flow reactor) wherein, under operation, the liquid is continuously fed into the reactor and it emerges as a continuous stream of liquid.

In one embodiment, the continuous-flow reactor of the invention is for mixing and/or reacting liquids and/or for mixing and/or reacting solids and liquids. In one embodiment, the continuous-flow reactor is for mixing and/or reacting solid particles in a liquid.

In one embodiment, the continuous-flow reactor comprises an inlet [100].

The term “inlet” is used herein in reference to an opening that may be used for intake. The inlet [100] hence may be used for the intake of liquid and/or solids, preferably liquid in the continuous-flow reactor of the invention.

In one embodiment, the inlet [100] is connected to an upstream fluidic network. In one embodiment, the continuous flow reactor of the invention comprises an upstream fluidic network. In one embodiment, said upstream fluidic network comprises means to push or circulate liquid into the continuous flow reactor of the invention. In one embodiment, said means to push or circulate liquid into the continuous flow reactor of the invention is a pump.

In one embodiment, the continuous-flow reactor of the invention comprises a swirl generator.

The term “swirl generator” is used herein in reference to a fluid conduit configured to generate a swirling flow downstream of said fluid conduit. The term relates in particular to a device which is designed to create a swirling or rotational flow pattern in a fluid, by introducing tangential velocity components. This is generally achieved without any rotating parts by diverting the axial flow into a tangential direction using for example and without limitation, fixed guide vanes or by introducing tangential injections of (a portion of) the fluid into the main passage. In one embodiment, the swirl generator does not contain any rotating part or impeller.

The terms “upstream” and “downstream” are used herein in reference to the liquid flow direction from the entry of liquid into continuous-flow reactor of the invention to the exit of liquid from the continuous-flow reactor of the invention.

Examples of swirl generators that may be used in the context of the invention include, without being limited to, tangential entry swirl generator and guided vanes swirl generator, such as that referenced in the example section.

In one embodiment, the swirl generator [101] is a tangential entry swirl generator or a guided vanes swirl generator. In one embodiment, the swirl generator is a guided vanes swirl generator.

In one embodiment, the swirl generator [101] is located downstream of the inlet [100] and/or the swirl generator is in fluid communication with the inlet [100].

The term “fluid communication” is used herein in reference to both liquid and gases communication.

In one embodiment, the swirl generator [101] is configured to transport fluids, preferably liquid, from the inlet [100] to the downstream part of the continuous flow reactor of the invention.

In one embodiment, the continuous-flow reactor of the invention comprises a mixing vessel [102].

In one embodiment, the mixing vessel [102], is located downstream of, and/or is in fluid communication with, preferably in direct fluid communication with, the outlet of the swirl generator [101].

In one embodiment, the mixing vessel [102] comprises a lower cylindrical part [103]. In embodiments of the present invention, the wall of the lower cylindrical part [103] is a part of the vessel wall (or enclosure). In embodiments, the mixing vessel [102] wall or enclosure comprises, or defines, the lower cylindrical part [103].

In one embodiment, the lower cylindrical part [103] is downstream of, and/or is in fluid communication with, preferably, direct fluid communication with, the outlet of the swirl generator [101].

In one embodiment, the mixing vessel [102] comprises an upper cylindrical part [104]. In embodiments of the present invention, the wall of the upper cylindrical part [104] is a part of the vessel wall or enclosure. In embodiments, the mixing vessel [102] wall or enclosure comprises, or defines, the upper cylindrical part [104].

In one embodiment, the diameter [d104] of the upper cylindrical part [104] is larger than the diameter [d103] of the lower cylindrical part [103].

In one embodiment, the diameter [d104] of the upper cylindrical part ranges from 270% to 670% of the diameter [d103] of the lower cylindrical part [103], preferably ranges from 280% to 660%, 290% to 650%, 300% to 640%, 310% to 640%, 320% to 630%, 330% to 620%, 340% to 610%, 350% to 600%, 360% to 600%, 370% to 600%, 380% to 600%, 390% to 600% or 400%, to 600%, of the diameter [d103] of the lower cylindrical part [103], more preferably ranges from 400% to 580% of the diameter [d103] of the lower cylindrical part [103].

In one embodiment, the length [l104] of the upper cylindrical part [104] is as high as possible to maximize the volume, for instance inferior or equal to 2200% of the diameter [d103] of the lower cylindrical part [103], preferably is inferior or equal to 2150%, 2100%, 2050%, 2000%, 1950%, 1900%, 1850%, 1800%, 1750%, 1730%, 1710%, 1690%, 1670%, 1650%, 1630%, 1610%, 1590%, 1570%, 1550%, 1530%, 1510%, 1490%, 1470%, 1450%, 1440%, 1430%, 1420%, 1410%, 1400%, 1390%, 1380%, 1370%, 1360%, 1350% or 1340% of the diameter [d103] of the lower cylindrical part [103], more preferably is inferior or equal to 1330% of the diameter [d103] of the lower cylindrical part [103]. In embodiments, the length [l104] of the upper cylindrical part [104] is superior or equal to 50% of the diameter [d103] of the lower cylindrical part [103], preferably is superior or equal to 100%, 150%, 200%, 250%, 300%, 350%, 360%, 370%, 380%, 390%, 400%, 410%, 420% or 430% of the diameter [d103] of the lower cylindrical part [103], more preferably is superior or equal to 440% of the diameter [d103] of the lower cylindrical part [103].

In one embodiment, the length [l104] of the upper cylindrical part [104] ranges from 50%, 100%, 150%, 200%, 250%, 300%, 350%, 360%, 370%, 380%, 390%, 400%, 410%, 420% or 430% to 2220% of the diameter [d103] of the lower cylindrical part [103], preferably ranges from 440% to 2200%, 440% to 2150%, 440% to 2100%, 440% to 2100%, 440% to 1950%, 440% to 1900%, 440% to 1850%, 440% to 1800%, 440% to 1780%, 440% to 1760%, 440% to 1740%, 440% to 1720%, 440% to 1700%, 440% to 1680%, 440% to 1660%, 440% to 1640%, 440% to 1620%, 440% to 1600%, 440% to 1580%, 440% to 1560%, 440% to 1540%, 440% to 1520%, 440% to 1500%, 440% to 1480%, 440% to 1460%, 440% to 1450%, 440% to 1430%, 440% to 1420%, 440% to 1410%, 440% to 1400%, 440% to 1390%, 440% to 1380%, 440% to 1370%, 440% to 1360%, 440% to 1350% or 440% to 1340% of the diameter [d103] of the lower cylindrical part [103], more preferably ranges from 440% to 1330% of the diameter [d103] of the lower cylindrical part [103].

In one embodiment, the mixing vessel [102] comprises a tapered part [105]. In one embodiment, the tapered part [105] connects the lower cylindrical part [103] with the upper cylindrical part [104]. In one embodiment, the tapered part [105] is located between the lower cylindrical part [103] and the upper cylindrical part [104]. In embodiments, the lower cylindrical part is located downstream from the swirl generator, the tapered part is located downstream from the lower cylindrical part, and the upper cylindrical part is located downstream from the tapered part. In one embodiment, the tapered part is connected to the lower cylindrical part [103]. In one embodiment, the tapered part is connected, preferably directly connected, to the upper cylindrical part [104]. In embodiments, the wall of the tapered part [105] is a part of the vessel wall or enclosure. In embodiments, the mixing vessel [102] wall or enclosure comprises, or defines, the tapered part [105].

In preferred embodiments, the mixing vessel [102] is defined by the walls or enclosures of the lower cylindrical part [103], the upper cylindrical part [104], and the tapered part [105]. Preferably, the walls or enclosures of the lower cylindrical part [103], the upper cylindrical part [104], and the tapered part [105] form the (most) outer parts of the mixing vessel [102]. Preferably, the continuous flow reactor is adapted so that there is fluid communication between the inlet [100] and the outlet [106] through the mixing vessel [102], but not from the outlet [106] to the inlet [100] via a fluidic path external to the mixing vessel [102].

In one embodiment, the wall of the tapered part [105] forms an angle α with the wall of the upper cylindrical part [104] that is (i) superior to 90 degrees, preferably superior or equal to 91, 92, 93 or 94 degrees, more preferably superior or equal to 95 degrees and/or (ii) inferior to 180 degrees, preferably inferior or equal to 165 degrees. The angle α between the wall of the tapered part [105] and the wall of the upper cylindrical part [104] is measured inside, i.e., in the interior of, the mixing vessel [102], so that, typically, a point within the angle α is located inside, i.e., in the interior of, the mixing vessel. In other words, the angle α may be considered to be an angle formed between the internal wall of the tapered part [105] and the internal wall of the upper cylindrical part [104] For example, the angle α is the internal angle between the wall of the tapered part [105] and the wall of the upper cylindrical part [104], in particular in a polygon substantially formed by a vertical cross-section of the mixing vessel.

In one embodiment, the mixing vessel [102] comprises an outlet [106].

The term “outlet” is used herein in reference to an opening that may be used for an outtake. The outlet [106] hence may be used for the outtake of liquid and/or solids, preferably liquid, out of the continuous-flow reactor of the invention.

In one embodiment, the outlet [106] is connected to a downstream fluidic network. In one embodiment, the continuous flow reactor of the invention comprises a downstream fluidic network. In one embodiment, said downstream fluidic network comprises means to draw in or circulate liquid into the continuous flow reactor of the invention. In one embodiment, said means to draw in or circulate liquid into the continuous flow reactor of the invention is a pump.

In one embodiment, the continuous flow reactor of the invention comprises a fluidic network, in fluid communication with the continuous flow reactor through the inlet [100] and/or the outlet [106] and wherein said fluidic network comprises means, preferably a pump, to push and/or drawn in liquid into the continuous flow reactor of the invention.

In one embodiment, the outlet [106] is located on the upper base [107] of the upper cylindrical part [104] and outside of the central part [107a] of the upper base [107] wherein said central part [107a] is a circle, concentric with the upper base [107], and with a radius [r107a] of 25% of the radius of the upper base [107], preferably with a radius [r107a] of 26%, 27%, 28%, 29%, 30%, 31% or 32% of the radius of the upper base [107], more preferably with a radius [r107a] of 33% of the radius of the upper base [107], even more preferably with a radius [r107a] of 40%, 45%, 50%, 55%, 60%, 61%, 62%, 63%, 64%, 65%, 66% or 67% of the radius of the upper base [107]. In embodiments, said central part [107a] is a circle, concentric with the upper base [107], and with a radius [r107a] of at least 25% of the radius of the upper base [107], preferably with a radius [r107a] of at least 26%, 27%, 28%, 29%, 30%, 31% or 32% of the radius of the upper base [107], more preferably with a radius [r107a] of at least 33% of the radius of the upper base [107], even more preferably with a radius [r107a] of at least 40%, 45%, 50%, 55%, 60%, 61%, 62%, 63%, 64%, 65%, 66% or 67% of the radius of the upper base [107]. In embodiments said central part [107a] is a circle, concentric with the upper base [107], and with a radius [r107a] ranging from 25% to 67% of the radius of the upper base [107], preferably with a radius [r107a] ranging from 26%, 27%, 28%, 29%, 30%, 31%, 32% or 33% to 67% of the radius of the upper base [107], more preferably with a radius [r107a] ranging from 40%, 45%, 50%, 55%, 60%, 61%, 62%, 63%, 64%, 65% or 66% to 67% of the radius of the upper base [107]. It is to be understood in the context of the invention that the upper base [107] of the upper cylindrical part [104] is also the upper base of the mixing vessel [102].

In one embodiment, the outlet [106] is in contact with the edge of the upper base [107] and/or the outlet [106] is located along the edge of the upper base [107].

In one embodiment, the outlet [106] is an annular outlet concentric with the upper base [107] of the mixing vessel [102]. In one embodiment, the outlet [106] is located along the edge of the upper base [107] and is an annular outlet concentric with the upper base [107] of the mixing vessel [102].

In one embodiment, the outlet [106] comprises a filter [108]. In one embodiment, said filter [108] is configured to prevent solid particles to flow through the outlet [106]. In one embodiment, the filter is a mesh filter.

In one embodiment, the mixing vessel [102] comprises, or consists of, the lower cylindrical part [103], the tapered part [105] and the upper cylindrical part [104]. In one embodiment, the mixing vessel [102] comprises, or consists of, the lower cylindrical part [103], the tapered part [105], the upper cylindrical part [104] and the outlet [106]. In one embodiment, the lower cylindrical part [103], the tapered part [105] and the upper cylindrical part [104] are aligned. In one embodiment, the lower cylindrical part [103], the tapered part [105] and the upper cylindrical part [104] are aligned in a vertical orientation. In one embodiment, the lower cylindrical part [103], the tapered part [105] and the upper cylindrical part [104] are aligned in a vertical orientation, with the lower cylindrical part [103] at the bottom and the upper cylindrical part [104] at the top.

In one embodiment, the dimensions of the mixing vessel [102] are configured to generate a Coanda flow of liquid, preferably an upward Coanda flow of liquid, along the wall of the tapered part [105] and the wall of the upper cylindrical part [104]. In one embodiment, a swirl number that the swirl generator [101] is adapted to provide, and the dimensions of the mixing vessel [102], are adapted to generate a Coanda flow of liquid, preferably an upward Coanda flow of liquid, along the wall of the tapered part [105] and the wall of the upper cylindrical part [104], when liquid is flowing through the reactor.

It is within the reach of the skilled artisan to adjust the swirl generator and dimensions of the mixing vessel to generate a Coanda flow of liquid in the mixing vessel [102] depending notably on the swirl number. For example, the adjustment principle is to gradually increase the swirl number until it produces a Coanda jet and use this minimum swirl number that produces a Coanda jet as the operating configuration. Of note, the Reynolds number is of limited influence on the formation of the Coanda jet as shown by Yang, et al. (“Identification and dynamics of coherent structures in a Coanda swirling jet flow”, Experimental Thermal and Fluid Science Volume 142, 1 Apr. 2023, 110817).

In one embodiment, the mixing vessel [102] is pressurized. In one embodiment, the mixing vessel [102] does not comprise any internal moving part. In one embodiment, the mixing vessel [102] does not comprise an impeller. In one embodiment, the mixing vessel [102] is a hollow structure. In one embodiment, the wall of the mixing vessel [102] further comprises a door. In one embodiment, the wall of the mixing vessel [102] further comprises a door for the filling of the mixing vessel [102] with solid particles.

In one embodiment, the swirl generator [101] is configured to generate a swirling flow of liquid in the lower cylindrical part [103].

In one embodiment, the swirl generator [101] is configured to achieve a swirl number sufficient to achieve a Coanda flow in the mixing vessel [102]. In one embodiment, the swirl generator [101] is configured to achieve a swirl number at or above 0.5. In one embodiment, the swirl generator [101] is configured to achieve a swirl number at or above 0.5, measured below the upper end of the lower cylindrical part [103] at a distance from said upper end corresponding to 30.2% of the diameter [d103] of the lower cylindrical part [103]. In one embodiment, the swirl generator [101] is configured to achieve a swirl number, measured below the upper end of the lower cylindrical part [103] at a distance from said upper end corresponding to 30.2% of the diameter [d103] of the lower cylindrical part [103], ranging from 0.5 to 2.5, preferably ranging from 1 to 1.7.

In one embodiment, the continuous flow reactor of the invention is positioned in a vertical orientation with its inlet [100] at the bottom and its outlet [106] at the top.

In one embodiment, the continuous flow reactor of the invention does not comprise a moving part. In one embodiment, the continuous flow reactor of the invention does not comprise an impeller.

In one embodiment, the mixing vessel [102] further comprises between the lower cylindrical part [103] and the tapered part [105], a nozzle [200]. It is to be understood in the context of the invention that a wall of the nozzle [200], when present, may be a part of the mixing vessel [102] wall or enclosure. In other words, in such embodiments, the mixing vessel [102] wall or enclosure comprises, or defines, a nozzle [200].

In one embodiment, the nozzle [200] comprises, or consists of, a first nozzle part [201].

In one embodiment, the nozzle [200] is located between the lower cylindrical part [103] and the tapered part [105]. In one embodiment, the nozzle [200] is connected to the lower cylindrical part [103] and to the tapered part [105].

In one embodiment, the nozzle [200] is a hollow structure. In one embodiment, the nozzle [200] does not comprise a central element. In one embodiment, the nozzle [200] is not a cyclonic nozzle.

In one embodiment, the nozzle [200] and the lower cylindrical part [103] form a hollow structure. In one embodiment, the nozzle [200] and the lower cylindrical part [103] do not comprise a central element. In one embodiment, the nozzle [200] and the lower cylindrical part [103] do not form a cyclonic nozzle.

In one embodiment, the nozzle [200] comprises, or consists of, a first nozzle part [201]. In one embodiment, first nozzle part [201] is located between the lower cylindrical part [103] and the tapered part [105]. In one embodiment, the first nozzle part [201] is connected, preferably directly connected, to the lower cylindrical part [103]. In one embodiment, the first nozzle part [201] is connected to the tapered part [105].

In one embodiment, the mixing vessel [102] comprises, or consists of, the lower cylindrical part [103], the first nozzle part [201], the tapered part [105] and the upper cylindrical part [104]. In one embodiment, the mixing vessel [102] comprises, or consists of, the lower cylindrical part [103], the first nozzle part [201], the tapered part [105], the upper cylindrical part [104] and the outlet [106]. In one embodiment, the lower cylindrical part [103], the first nozzle part [201], the tapered part [105] and the upper cylindrical part [104] are aligned. In one embodiment, the lower cylindrical part [103], the first nozzle part [201], the tapered part [105] and the upper cylindrical part [104] are aligned in a vertical orientation. In one embodiment, the lower cylindrical part [103], the first nozzle part [201], the tapered part [105] and the upper cylindrical part [104] are aligned in a vertical orientation, with the lower cylindrical part [103] at the bottom and the upper cylindrical part [104] at the top.

In one embodiment, the wall of the first nozzle part [201] forms an angle R with the wall of the lower cylindrical part [103] that is superior or equal to 90 degrees and inferior to 180 degrees. The angle R between the wall of the first nozzle part [201] and the wall of the lower cylindrical part [103] is measured outside of, i.e., external to, the mixing vessel [102], so that, typically, a point within the angle R is located outside, i.e., external to, the mixing vessel. In other words, the angle R is an angle formed between the external wall of the lower cylindrical part [103] and the external wall of the mixing vessel [102].

In one embodiment, the projected width [w201], e.g. the horizontally projected width, of the first nozzle part [201] is inferior or equal to 80% of the diameter [d103] of the lower cylindrical part [103] preferably inferior or equal to 79%, 78%, 77%, 76%, 75%, 74%, 73%, 72%, 71%, 70% 69% or 68% of the diameter [d103] of the lower cylindrical part [103], more preferably inferior or equal to 67% of the diameter [d103] of the lower cylindrical part [103]. In one embodiment, the projected width [w201] of the first nozzle part [201] is superior or equal to 1% of the diameter [d103] of the lower cylindrical part [103] for instance superior or equal to 10%, such as superior or equal to 15% of the diameter [d103] of the lower cylindrical part [103]. In one embodiment, the projected width [w201] of the first nozzle part [201] ranges from 1%, 5%, 10% or 15% to 80% of the diameter [d103] of the lower cylindrical part [103] preferably ranges from 1%, 5%, 10% or 15% to 79%, from 1%, 5%, 10% or 15% to 78%, from 1%, 5%, 10% or 15% to 77%, from 1%, 5%, 10% or 15% to 76%, from 1%, 5%, 10% or 15% to 75%, from 1%, 5%, 10% or 15% to 74%, from 1%, 5%, 10% or 15% to 73%, from 1%, 5%, 10% or 15% to 72%, from 1%, 5%, 10% or 15% to 71%, from 1%, 5%, 10% or 15% to 70%, from 1%, 5%, 10% or 15% to 69% or from 1%, 5%, 10% or 15% to 68% of the diameter [d103] of the lower cylindrical part [103], for instance ranges from 1%, 5%, 10% or 15% to 67% of the diameter [d103] of the lower cylindrical part [103]. The projected width [w201] of the first nozzle part [201] corresponds to the projection on the horizontal axis of the width of the first nozzle part [201].

In one embodiment, the nozzle [200] comprises, or consists of, the first nozzle part [201] and the second nozzle part [202]. In one embodiment, the second nozzle part [202] is connected to, preferably directly connected to the first nozzle part [201] and the tapered part [105]. In one embodiment, the second nozzle part [202] is located between the first nozzle part [201] and the tapered part [105].

In one embodiment, the mixing vessel [102] comprises, or consists of, the lower cylindrical part [103], the first nozzle part [201], the second nozzle part [202], the tapered part [105] and the upper cylindrical part [104]. In one embodiment, the mixing vessel [102] comprises, or consists of, the lower cylindrical part [103], the first nozzle part [201], the second nozzle part [202], the tapered part [105], the upper cylindrical part [104] and the outlet [106]. In one embodiment, the lower cylindrical part [103], the first nozzle part [201], the second nozzle part [202], the tapered part [105] and the upper cylindrical part [104] are aligned. In one embodiment, the lower cylindrical part [103], the first nozzle part [201], the second nozzle part [202], the tapered part [105] and the upper cylindrical part [104] are aligned in a vertical orientation. In one embodiment, the lower cylindrical part [103], the first nozzle part [201], the tapered part [105] and the upper cylindrical part [104] are aligned in a vertical orientation, with the lower cylindrical part [103] at the bottom and the upper cylindrical part [104] at the top.

In one embodiment, the wall of the second nozzle part [202] forms an angle γ with the vertical axis of the mixing vessel [102]. In one embodiment, the wall of the second nozzle part [202] forms an angle γ with the vertical axis of the mixing vessel [102], that is superior or equal to 0 degrees and inferior or equal to 90 degrees. The angle γ is the angle formed by the wall of the second nozzle part [202] with the vertical axis of the mixing vessel [102] in the outer and outward position (or inner and downward position). In one embodiment, the wall of the second nozzle part [202] forms an angle γ with the vertical axis of the mixing vessel [102] and toward the upper and outer sides of the mixing vessel [102], which is superior or equal to 0 degrees and inferior or equal to 90 degrees.

In embodiments wherein the nozzle [200] comprises, or consists of the first nozzle part [201] and the second nozzle part [202], the angle γ is different from 180 degrees minus the angle α and different from the 180 minus the angle β.

In embodiments wherein the nozzle [200] does not comprise the second nozzle part [202], the angle α is different from the angle β.

In one embodiment, the projected height [h202] of the second nozzle part [202] is inferior or equal to 89% of the diameter [d103] of the lower cylindrical part [103], preferably inferior or equal to 85%, 80%, 75%, 70%, 65% or 60% of the diameter [d103] of the lower cylindrical part [103], more preferably inferior or equal to 59%, 58%, 57%, 56%, 55%, 54% 53%, 52%, 51%, 50%, 49%, 48%, 47%, 46% or 45% of the diameter [d103] of the lower cylindrical part [103], even more preferably inferior or equal to 44% of the diameter [d103] of the lower cylindrical part [103]. In embodiments, the projected height [h202] of the second nozzle part [202] is superior or equal to 1% of the diameter [d103] of the lower cylindrical part [103], preferably superior or equal to 10% of the diameter [d103] of the lower cylindrical part [103], more preferably superior or equal to 20% of the diameter [d103] of the lower cylindrical part [103], even more preferably superior or equal to 40% of the diameter [d103] of the lower cylindrical part [103]. In embodiments, the projected height [h202] of the second nozzle part [202] ranges from 1%, 10%, 20% or 40% to 89% of the diameter [d103] of the lower cylindrical part [103], preferably ranges from 1%, 10%, 20% or 40% to 85%, from 1%, 10%, 20% or 40% to 80%, from 1%, 10%, 20% or 40% to 75%, from 1%, 10%, 20% or 40% to 70%, from 1%, 10%, 20% or 40% to 65% or from 1%, 10%, 20% or 40% to 60% of the diameter [d103] of the lower cylindrical part [103], more preferably ranges from 1%, 10%, 20% or 40% to 59%, from 1%, 10%, 20% or 40% to 58%, from 1%, 10%, 20% or 40% to 57%, from 1%, 10%, 20% or 40% to 56%, from 1%, 10%, 20% or 40% to 55%, from 1%, 10%, 20% or 40% to 54% from 1%, 10%, 20% or 40% to 53%, from 1%, 10%, 20% or 40% to 52%, from 1%, 10%, 20% or 40% to 51%, from 1%, 10%, 20% or 40% to 50%, from 1%, 10%, 20% or 40% to 49%, from 1%, 10%, 20% or 40% to 48%, from 1%, 10%, 20% or 40% to 47%, from 1%, 10%, 20% or 40% to 46% or from 1%, 10%, 20% or 40% to 45% of the diameter [d103] of the lower cylindrical part [103]. The projected height [h202] of the second nozzle part [202] corresponds to the projection on the vertical axis of the height of the second nozzle part [202].

In one embodiment, the mixing vessel [102] further comprises a central draft tube [300]. In one embodiment, the central draft tube [300] is configured to separate the central downward flow of liquid from the outer upward flow of liquid when liquid is flowing through the reactor. In one embodiment, the upper end of the central draft tube [300] is widening to form a funnel.

The present invention further relates to the use of the continuous-flow reactor of the invention for mixing and/or reacting solid particles with a fluid, preferably for mixing solid particles with a liquid. In one embodiment, the use of the continuous-flow reactor of the invention is for mixing and/or reacting particles comprising, or consisting, of wood with a liquid comprising, or consisting of, methanol.

The present invention further relates to a method of mixing and/or reacting solid particles, preferably particles comprising or consisting of wood, with a fluid, preferably with a liquid, preferably a liquid comprising, or consisting of, methanol.

In one embodiment, the method of the invention comprises the steps of,
a. placing solid particles, preferably particles comprising or consisting of wood, in the mixing vessel [102] of the continuous flow reactor of the invention, and
b. circulating liquid, preferably liquid comprising, or consisting of methanol, through the continuous flow reactor of the invention.

### EXAMPLES

The present invention is further illustrated by the following examples.

### Example 1: Design and Parameters of the Reactor Mixing Vessel

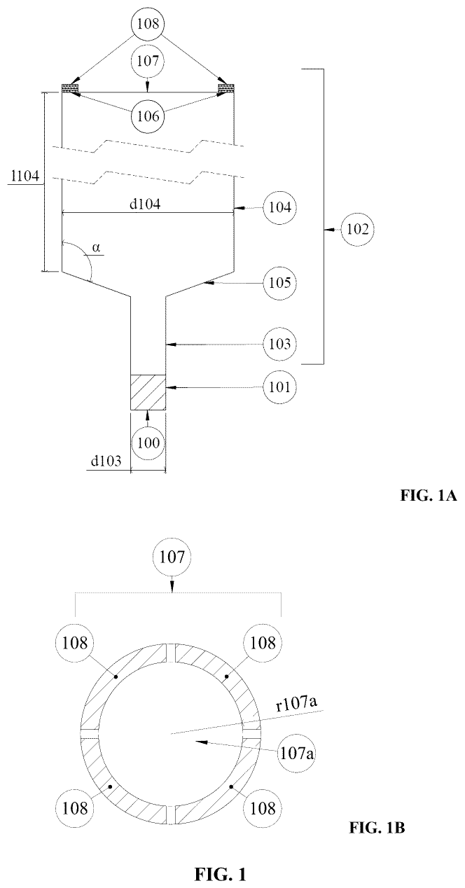

The continuous flow reactor can be seen in FIG. 1a. The continuous flow reactor comprises a reactor inlet [100] that is connected to the intake of a swirl generator [101]. A mixing vessel [102] is directly connected to the outlet of the swirl generator [101]. There are no moving parts (agitation tank) or complex structures (passive mixing channels) inside the mixing vessel [102]. Therefore, only fixed piping connections are required for the continuous flow reactor and there is no problem with sealing moving parts. The mixing vessel [102] comprises 3 parts: (i) a lower cylindrical part [103] directly connected to the outlet of the swirl generator [101], (ii) an upper cylindrical part of diameter [d104] larger than the diameter [d103] of the lower cylindrical part [103] and (iii) a tapered part [105] connecting the lower cylindrical part [103] with the upper cylindrical part [104]. The outlet [106] is an annular outlet and it is located at the edge of the upper base [107] of the mixing vessel as illustrated in FIG. 1b. The outlet [106] may be equipped with a filter [108] to confine the particles within the mixing vessel [102].

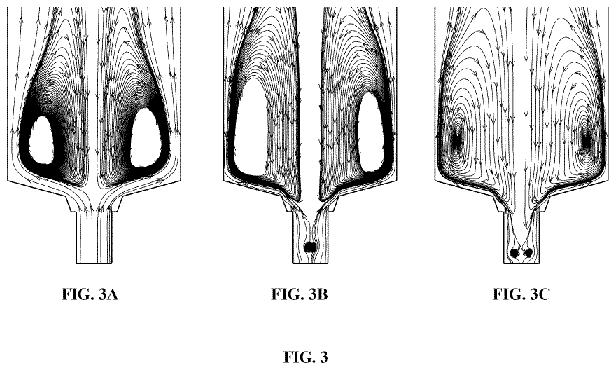

Swirling flow mixing technology can provide good uniformity and high mixing vessel utilization. The most essential principle to implement swirling flow mixing is the Coanda flow, which is generated from the highly swirled jet flow. The swirl number Sw is calculated based on the velocity profiles at 6.8 mm (0.302 times the diameter of the lower cylindrical part [103]) below the upper end of the lower cylindrical part [103]. The swirl number Sw is the ratio between the axial flux of tangential momentum and the axial flux of axial momentum divided by a characteristic radius, and is defined as:

$${S}_{w} = \frac{{\int }_{{R}_{i}}^{{R}_{0}} \vert \overline{u} \vert \overline{w} {r}^{2} dr}{{R}_{0} {\int }_{{R}_{i}}^{{R}_{0}} \vert \overline{u} \vert \vert \overline{u} \vert rdr} ,$$

where u and w are instantaneous axial and tangential velocities and the overbar denotes time-averaged velocity components. As illustrated in FIGS. 3a-c, with swirl numbers equal to 0.5, 1.0 and 1.2, the jet is a Coanda flow and the bulk flow flows close to the tapered part [105] of the mixing vessel [102]. The ideal Coanda flow in the mixing vessel [102] will completely cover the tapered part [105] of the mixing vessel [102], with no or very little recirculation between the tapered part [105] of the mixing vessel [102] and the Coanda flow. This prevents the accumulation of solid particles on the tapered part [105] of the mixing vessel [102]. An important principle for achieving swirling flow mixing is the circulation of particles in the vessel, the particles flow from the outer side of the mixing vessels [102] towards the outlet [106] led by the Coanda flow and return, by gravity, to the bottom of the mixing vessel [102] in the central part of the mixing vessel [102]. This ensures that the majority of particles are effectively mixed, and this requires the localization of the outlet [106] near, preferably in contact with, the edge of the upper base [107] of the mixing vessel [102]. Achieving such a Coanda flow will not only depend on the swirl number but also on the design of the mixing vessel [102].

Therefore, the geometrical parameters involved in the working of the mixing vessel [102] were discussed and determined. The simulation and discussion in this example are based on a prototype with a capacity of 2 L and a diameter [d103] of the lower cylindrical part [103] of 22. 5 mm. The particles specific gravity is 1.7. The solid concentration is 20 vol %, the flow rate 18 L/s and the swirl number, determined 6.8 mm below the upper end of the lower cylindrical part [103], at the inlet of 1.2. Although the parameters determined below may be mentioned to be optimal or required (e.g., to achieve Coanda flow) for a mixing vessel associated with the above variables (e.g., swirl number and diameter of the lower cylindrical part), different parameters may be optimal or required for mixing vessels associated with different variables. The detailed method is provided in the following example 2.

The results are presented as a contour plot of particle concentrations in cross-section of the mixing vessel [102] and are scaled up to illustrate the difference in particle concentration. Also, streamlines for checking Coanda flow and recirculation of particles have been plotted.

### Length of the Upper Cylindrical Part [104]

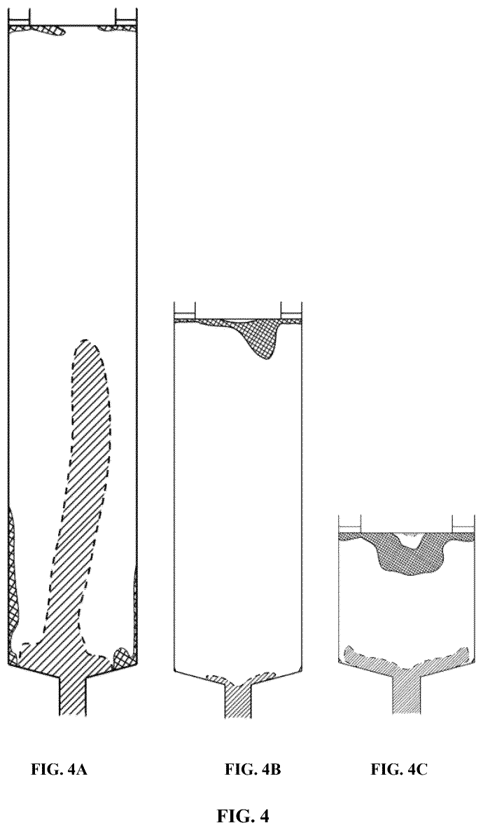

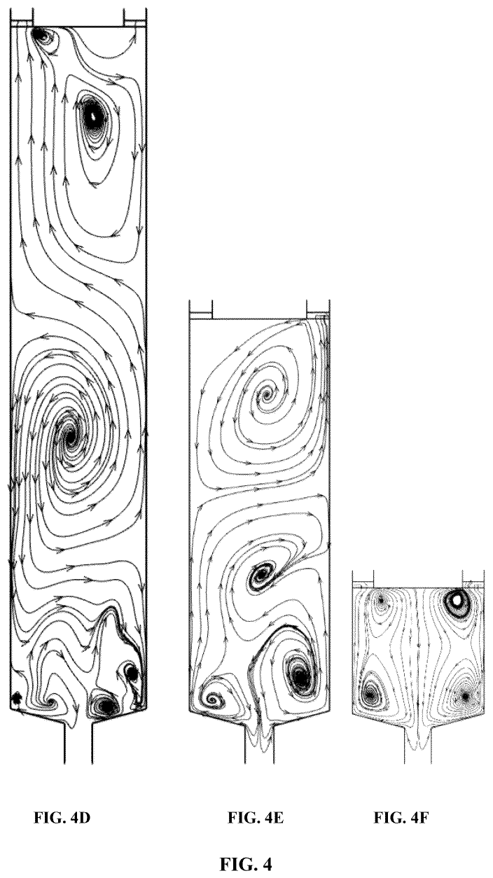

The length [l104] of the upper cylindrical part [104] is not a parameter that has a significant impact on the continuous flow reactor operation. Here the length [l104], as drawn in FIG. 1a, is defined as the distance from the bottom to the top of the upper cylindrical part [104]. FIGS. 4a-e illustrate the simulation results for varying length [l104], as drawn on FIG. 1. When the length [l104] is too short (FIGS. 4c and f, [l104]=100 mm), the mixing vessel [102] capacity is too small and lacks practicality meanings, but the continuous flow reactor can still operate properly. When the length [l104] is too long (FIGS. 4a and d, [l104]=550 mm) the continuous flow reactor operation is compromised. At the level of the tapered part [105], near the sidewall, a large accumulation of particles occurs, and the Coanda flow has been prematurely separated from the wall by the compression of dense accumulated particles. Therefore, taking into account that there is no accumulation of particles at the bottom, a length [l104] of the upper cylindrical part [104] below 300 mm-13.3 times the diameter of the lower cylindrical part [103] ensures better performance of the continuous flow reactor. In practice, it is better to use [l104] between 100 mm and 300 mm, which is 4.4 to 13.3 times the diameter of the lower cylindrical part [103]. A simulation result with a [l104] of 300 mm is shown in FIGS. 4b and e.

### Diameter of the Upper Cylindrical Part [104]

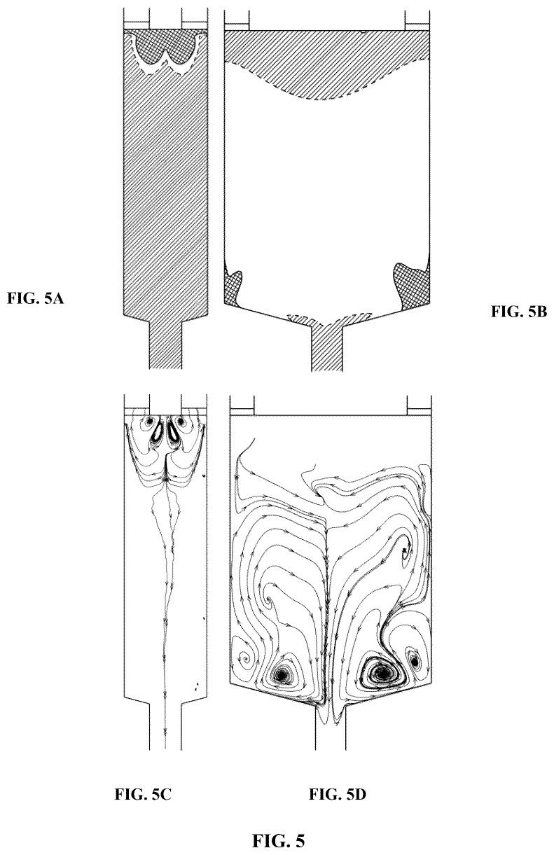

When the diameter [d104] of the upper cylindrical part [104], as drawn in FIG. 1a, is too small, the cross-sectional area of the mixing vessel [102] is reduced and the axial velocity in the mixing vessel [102] increases. This causes all particles to be trapped in front of the filter [108] and unable to circulate in the mixing vessel [102], as shown in FIGS. 5a and c, which is a case with a diameter of 60 mmm—2.7 times the diameter of the lower cylindrical part [103]. On the other hand, when the diameter increases, the Coanda flow will detach from the wall of the upper cylindrical part [104] prematurely, thus losing the ability to wash the tapered part [105]. The particles will accumulate on the tapered part [105] of the mixing vessel [102], as shown in FIGS. 5b and d, which is a case with a diameter of 150 mm, that 6.7 times the diameter [d103] of the lower cylindrical part [103].

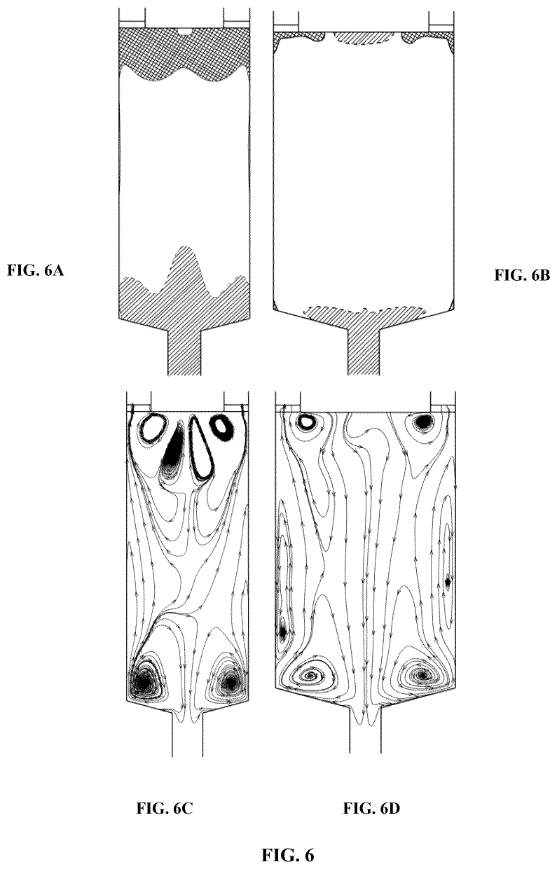

A diameter [d104] for the upper cylindrical part [104], ranging from 90 mm to 130 mm-4 times and 5.8 times the diameter [d103] of the lower cylindrical part [103]—ensures a relatively even distribution of particles and limited accumulation thereof on the tapered part [105] of the mixing vessel [102]. As shown, in FIGS. 6a and c, in a case with a diameter [d104] of 90 mm, that is 4 times the diameter [d103] of the lower cylindrical part [103]. The accumulation of particles in front of the filter [108] has increased, but there is still a relatively uniform particle distribution in the mixing vessel [102], and mixing vessels with smaller diameters will work less efficiently. A case with a diameter [d104] of 130 mm—5.8 times the diameter of the lower cylindrical part [103]—is illustrated by FIGS. 6b and d. Coanda flow can no longer be maintained to the sidewall surface but a limited amount of particle accumulation is seen. Therefore, larger diameters will lead to excessive accumulation.

### Outlet [106]

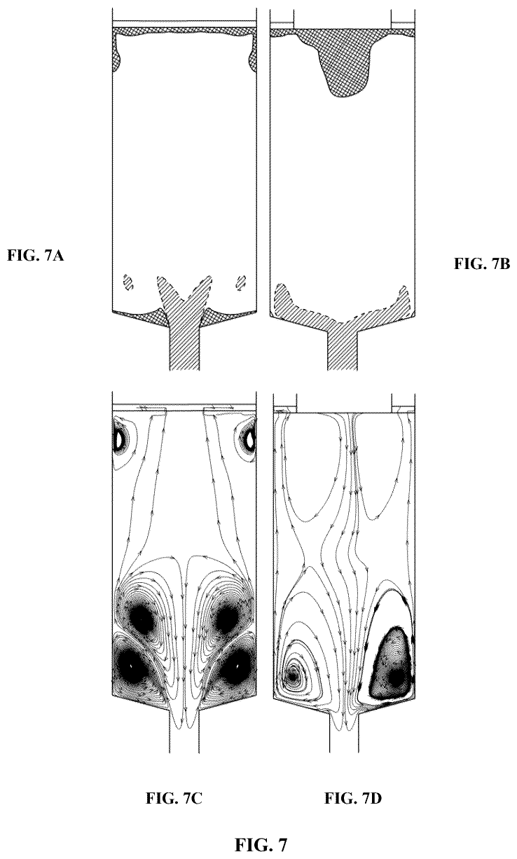

The mixing vessel [102] requires the use of an outlet [106] located along the edge of the base [107] of the mixing vessel [102], which helps to create a downward flow in the center of the mixing vessel [102]. When using a circular flat outlet [106] equipped with a filter [108] covering the entire base [107] of the mixing vessel [102], fluid flows out through the entire outlet [106] and particles accumulate in front of the filter [108] as shown in FIGS. 7a and c. Due to the low flow velocity near the wall, the particles sink along the wall of the upper cylindrical part [104] and get in between the Coanda flow and the tapered part [105]. The Coanda flow will not be able to wash the excessive particle accumulation, and the accumulated particles will impair the Coanda flow. When using an outlet [106] located along the edge of the base [107] such as for instance in this case an annular outlet as drawn in FIG. 1b, particles sink from the middle area and are wrapped up by the Coanda flow preventing accumulation of particles on the tapered part [105] as shown in FIGS. 7b and d. The outlet [106] is preferably located outside of the central part of the base [107] of the mixing vessel [102]. The best results are achieved when the outlet [106] is outside the central part of the base [107]—i.e. outside the area [107a] as drawn in FIG. 1b of radius [r107a] being 25% of that of the base [107]. Best performance is achieved when the outlet is located outside the area [107a] of radius [r107a] being 33% of that of the base [107]. Larger central areas (e.g., radius [r107a] being 67% of that of the base [107]) also provide for good results.

### Mixing Vessel Inlet Configurations

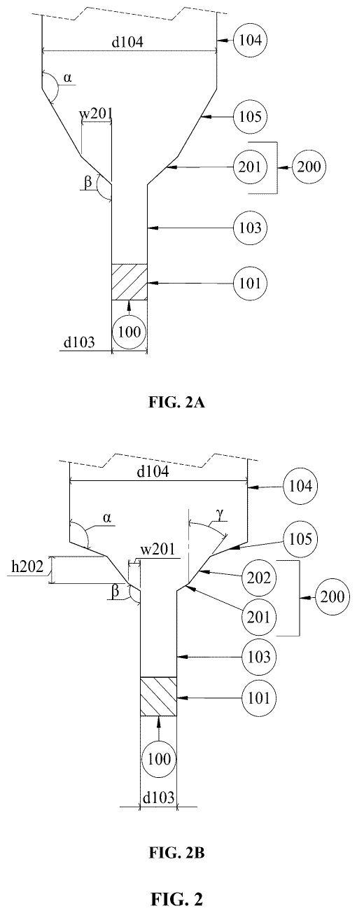

An influential aspect for the functioning of the continuous flow reactor is the formation of a Coanda flow along the walls of the tapered part [105] of the mixing vessel, which is related to the design of the inlet of the mixing vessel [102]. There are three types of inlet designs, without nozzle, as illustrated in FIG. 1a or with the addition of a nozzle [200] that may be a conical nozzle illustrated in FIG. 2a or a stepped nozzle as illustrated in FIG. 2b. In each of these three cases and unlike what is seen in most cyclone nozzles that have an annular inlet design, a circular inlet design is required to avoid the accumulation of particles in the center of the inlet that would break the Coanda flow.

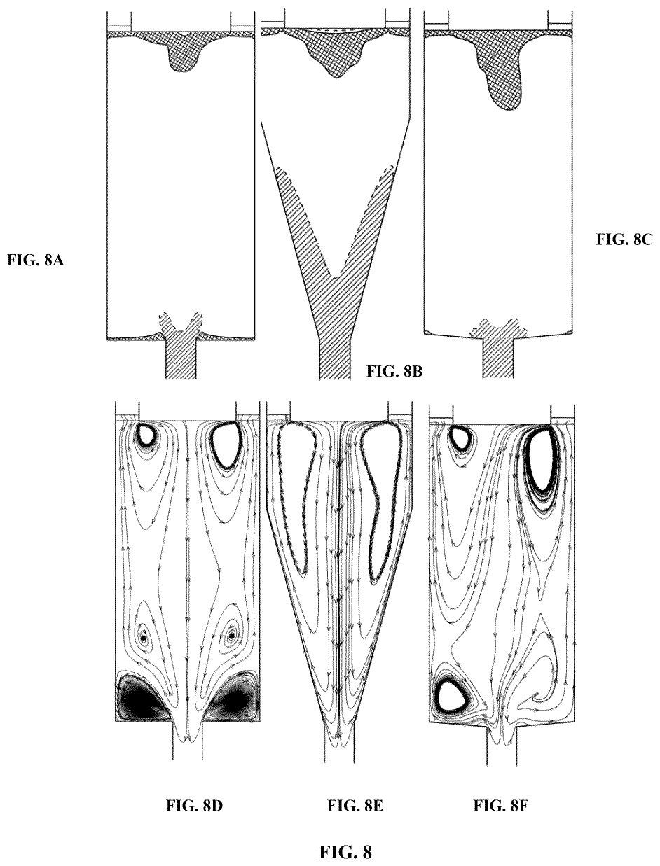

In a configuration without nozzle [200] the angle α, measured inside, i.e., in the interior of, the mixing vessel [102], between the wall, e.g., internal wall, of the tapered part [105] and the wall, e.g., internal wall, of the upper cylindrical part [104], as shown in FIG. 1a, is a parameter that was found to influence the efficiency of the mixing. When a is 90 degrees, the tapered part [105] is horizontal. As shown in FIGS. 8a and d, recirculation of the particles is then seen at the bottom of the vessel, near the wall tapered part [105], which impairs a Coanda flow and leads to particle accumulation near the tapered part [105]. When the angle is larger, the mixing vessel becomes a conical structure, which does not affect Coanda flow formation and particle mixing. For example, the angle of the case in FIGS. 8b and e is α=165 degrees, the particle distribution is uniform, and no particle accumulates at the bottom. However, this is not conducive to manufacturing, and the same capacity requires a longer reactor, and the mixing vessel [102] may not work properly when it is too long. At the same time, the large gradient in particle distribution in the vessel is not ideal. It is presented here only as an upper limit of what is feasible in a mixing vessel [102] and is not recommended. When the angle α is 95 degrees, the formation of Coanda flow is observed without recirculation near the tapered part [105] as shown in FIGS. 8c and f. Therefore, the angle α must be superior to 90 degrees, with the best performance being observed with an angle at or above 95 degrees and below 165 degrees.

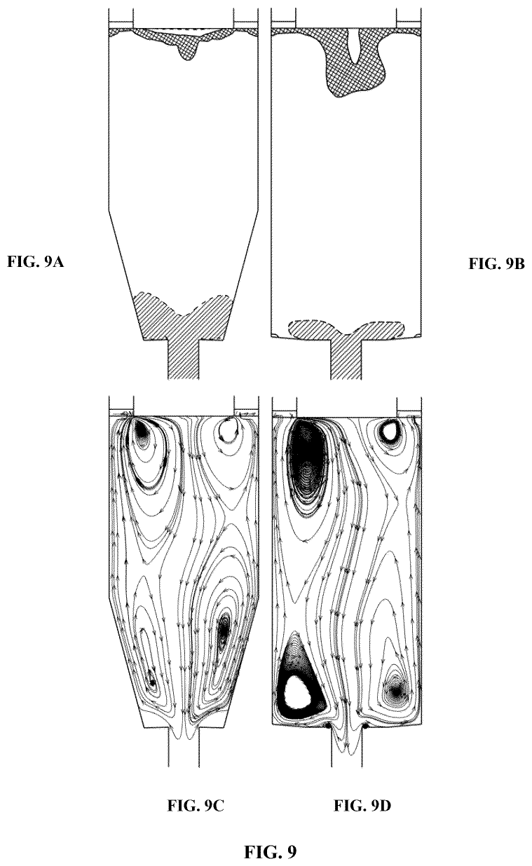

A configuration of the mixing vessel [102] with a conical nozzle can be used for the continuous-flow reactor. In this configuration, the design illustrated in FIG. 1a further comprises, as illustrated in FIG. 2a, between the lower cylindrical part [103] of the mixing vessel [102] and the tapered part [105] of the mixing vessel [102], a nozzle [200] comprising a first nozzle part [201], wherein the wall of the lower cylindrical part [103] and the wall of the first nozzle part [201] part form an angle β, measured outside of, i.e., external to, the mixing vessel [102], indicated in FIG. 2a. The angle β is different from the angle α as such a configuration would result in the walls of the tapered part [105] and the wall of the first nozzle part [201] being aligned. For the angle α, the dimensional limits are the same as for the configuration without nozzle. The angle R can be superior or equal to 90 degrees and inferior to 180 degrees. When the angle R is equal to 90 degrees, the first nozzle part [201] is horizontal, and this is the most likely situation for particle accumulation. Therefore, this was used as a reference to determine the upper limit of the projected width [w201](indicated on FIG. 2a) of the first nozzle part [201] as being 0.67 times the diameter [d103] of the lower cylindrical part [103] for best performance. As shown in FIG. 9, with a projected width [w201], as illustrated in FIG. 2a, of the first nozzle part [201] of 15 mm—0.67 times the diameter [d103] of the lower cylindrical part [103]—and the angle α of 95 degrees (FIGS. 9b and d) or 165 degrees (FIGS. 9a and c), the particle distribution is uniform and bottom accumulation is limited. Although there is recirculation at the bottom in the case of an angle α being 165 degrees, the accumulation of particles is still acceptable.

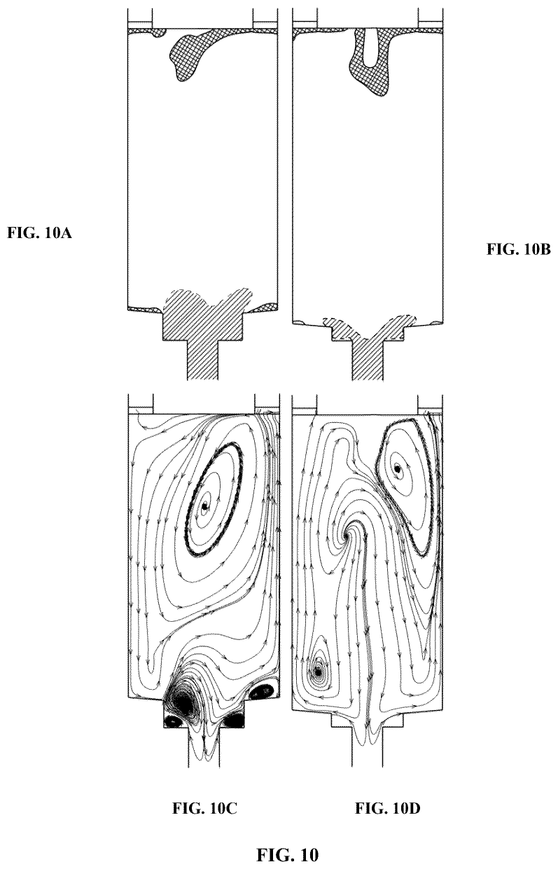

A configuration of the inlet of the mixing vessel [102] with a stepped nozzle can be used for the continuous flow reactor. Such a configuration allows the generation of Coanda flow at low flow rates and swirl numbers. In this configuration the design illustrated in FIG. 1a further comprise, as illustrated in FIG. 2b, between the lower cylindrical part [103] of the mixing vessel [102] and the tapered part [105] of the mixing vessel [102], a nozzle [200] comprising a first nozzle part [201], wherein the wall of the lower cylindrical part [103] and the wall of the first nozzle part [201] part form an angle β, measured outside of, i.e., external to, the mixing vessel [102], and a second nozzle part [202] between the first nozzle part [201] and the tapered part [105], wherein the wall of the second nozzle part [202] and the vertical axis of the mixing vessel [102] form an angle γ, as illustrated in FIG. 2b. For the angle α, the dimensional limits are the same as for the configuration without nozzle. The angle γ is comprised between 0 and 90 degrees and is different from (180 degrees−β) and from (180 degrees−α) as these configurations would results in wall of the second nozzle part [202] being aligned with that of the first nozzle part [201] and/or that of the tapered part [105]. When the angle β is 90 degrees, and the angle γ is zero degrees, the wall of the first nozzle part [201] is horizontal, and the wall of second nozzle part [202] is vertical. This configuration is potentially the one with the greatest impact on the Coanda flow. Therefore, the projected width [w201] of the first nozzle part [201] and the projected height [h202](as illustrated in FIG. 2b) of the second nozzle part [202] of the step will be determined at these values of angles. The minimum value of both the projected width [w201] of the first nozzle part [201] and the projected height [h202] of the second nozzle part [202] is 0, and the step structure does not exist, which has the same structure as the configuration without a nozzle as above. However, when the projected width [w201] of the first nozzle part [201] or the projected height [h202] of the second nozzle part [202] is too large, it tends to disrupt the Coanda flow and particles accumulate near the wall of the nozzle [200], as show in FIGS. 10a and c when the projected height [h202] of the second nozzle part [202] of 20 mm—0.89 times the diameter [d103] of the lower cylindrical part [103]—and the projected width [w201] of the first nozzle part [201] of 18 mm—0.8 times the diameter [d103] of the lower cylindrical part [103]. In such case, the Coanda flow is blocked by the stepped nozzle and the mixing vessel [102] may not work properly. Whereas when the projected height [h202] of the second nozzle part [202] is 10 mm—0.44 times the diameter [d103] of the lower cylindrical part [103]—and the projected width [w201] of the first nozzle part [201] of 15 mm—0.67 times the diameter [d103] of the lower cylindrical part [103], the Coanda flow is not blocked and the mixing vessel can operate properly as shown in FIGS. 10b and d. In conclusion, the best performance is observed when the projected width [w201] is inferior to 0.44 times the diameter [d103] of the lower cylindrical part [103] and the projected height [h202] of the second nozzle part [202] is inferior to 0.67 times the diameter [d103] of the lower cylindrical part [103].

### Example 2: Performance of the Continuous Flow Reactor

### Materials and Methods

### Design of the Continuous Flow Reactor

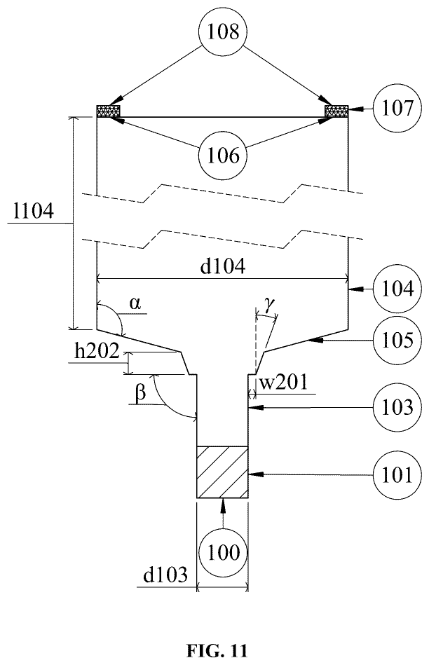

The mixing vessel [102] used corresponds to a configuration of the mixing vessel [102] with a stepped nozzle as described in example 1. The design is illustrated by FIG. 11. The dimensions used are indicated in table 1,

TABLE 1
dimensions of the mixing vessel [102] used in example 2

| | | |
|---|---|---|
| reference | dimension | length/d103 |

| | | | |
|---|---|---|---|
| d103 | 22.5 | mm | 1.00 |
| w201 | 3.38 | mm | 0.15 |
| h202 | 9.833 | mm | 0.44 |
| d104 | 110 | mm | 4.89 |
| [1104] | 200 | mm | 8.89 |
| γ | 15 | degrees | na |
| β | 90 | degrees | na |
| α | 105 | degrees | na |

An outlet [106] in contact with the edge of the base [107] and of annular shape, as illustrated in FIG. 1b is used. The inner radius [r107a] of the annular outlet is 37 mm, corresponding to 67% of the radius of the upper base [107]. The outlet [106] comprises a filter [108] to confine particles within the mixing vessel [102].

A swirl generator [101] is connected to the intake of the lower cylindrical part [103] to generate a swirling flow in the lower cylindrical part [103] (a ratio of tangential flux momentum to axial flux momentum higher than zero). For this specific case, the swirl number is 1.2 measured at 6.8 mm below the upper end of the lower cylindrical part [103]. The increase of tangential flux momentum to axial flux momentum is obtained by a device called ‘swirl generator’, commonly known in the industry, which produces swirl without incorporating rotating parts. For example, like the adjustable guide vane swirl generator used in Zhang and Vanierschot (Physics of Fluids 33, 015115-2021—doi 10.1063/5.0032985).

### CFD Simulation

The present study performed U-RANS simulations by adopting a predictive approach based on the Eulerian-Eulerian model as implemented in the commercial CFD code Fluent V19.1. The continuity and momentum equations are solved for each phase, and the momentum exchange coefficient between solid-liquid phases is calculated using the Huilin-Gidaspow model, which is a combination of the Wen and Yu model and the Ergun equation. In addition, the turbulent simulations are performed using a realizable k-ε turbulence model, and the primary phase's turbulent predictions are obtained from the modified k-ε model. For the dispersed phase, the turbulence predictions are obtained using Tchen's theory of dispersion of discrete particles rather than transport equations, in which time and length scales that characterize the motion are used to evaluate turbulence quantities. The function of the filter is modeled using a porous media model. This approach significantly reduces the computational time and CPU power requirements compared to modelling and simulating the detailed structure of the filter. This model presents as an additional momentum source term to the standard fluid flow equations, which is composed of a viscous term and an inertial loss term. In this study, an extremely large inertia loss is applied to the solid particle phase to simulate the stopping of particle movement in the filter. Pointwise was used to discretize the flow domain into discrete control volumes with hexahedral cells (structured grid). The advantage of using a structured grid are smaller memory requirements and computing times (J.-R. Sack, and J. Urrutia. Handbook of Computational Geometry. Elsevier Science & Technology, 1999). In addition, all the grid cells are hexahedral to meet the requirements for aspect ratio, non-orthogonality, and skewness. The number of elements is about 1.5×10⁶ in total. The coupled pressure/velocity fields are obtained using the Coupled algorithm (solves all equations for phase velocity corrections and shared pressure correction simultaneously) at each time step. The temporal derivative term is discretized using a second-order implicit scheme. The QUICK (Quadratic Upstream Interpolation for Convective Kinematics) differencing scheme is used for momentum, volume fraction, turbulence kinetic energy and turbulence dissipation rate discretization, which is approved to give the most accurate results when strong gradients are expected. Additionally, the PRESTO!differencing scheme is used for pressure discretization, and Last Squares cell based differencing scheme is used for gradient discretization. Modeling of the near wall zones was accomplished using non-equilibrium wall functions, which is recommended for use in complex flows involving separation, reattachment, and impingement. All the simulations were carried out at a time step of 0.0002 s. Each time step was considered converged when the unscaled residuals for all transport equations dropped 3 decades for the respective time step.

The fluid dynamics related conditions for the CFD simulations are derived from the conditions required for the RCF reaction and are presented in table 2.

TABLE 2
Simulation conditions

| Variables | Value | |
|---|---|---|
| Solid concentration | 20 | vol % |
| Specific gravity | 1.75 | |
| Flow rate | 18.8 | L/min |

The first control parameter of the system is the Reynolds number Re, which is calculated based on the velocity profiles at 6.8 mm (30.2% of the inlet diameter) below the upper end of the lower cylindrical part [103]. The Reynolds number is defined as:

$$Re = \frac{{u}_{o} {D}_{h}}{v} ,$$

where

$${u}_{o} = 1.2 \; 34 \frac{m}{s}$$

is the mean axial velocity in the lower cylindrical part [103], Dₕ=22.5 mm is the hydraulic diameter of lower cylindrical part [103], and

$$v = 1.37 \times 10 - 7 \frac{{m}^{2}}{s}$$

is the kinematic viscosity of the fluid.

The second control parameter of the system is the swirl number Sw, which is calculated based on the velocity profiles at 6.8 mm (30.2% of the inlet diameter) below the upper end of the lower cylindrical part [103]. The swirl number Sw is the ratio between the axial flux of tangential momentum and the axial flux of axial momentum divided by a characteristic radius, and defined as:

$$Sw = \frac{{\int }_{{R}_{i}}^{{R}_{0}} \vert \overline{u} \vert \overline{w} {r}^{2} dr}{{R}_{0} {\int }_{{R}_{i}}^{{R}_{0}} \vert \overline{u} \vert \vert \overline{u} \vert rdr} ,$$

where u and w are instantaneous axial and tangential velocities, and the overbar denotes time-averaged velocity components. The computed Reynolds number Re is around 130000, and the swirl number Sw is calculated as 1.2.

### Results and Conclusions

The continuous flow reactor is based on the flowthrough reactor idea, where the catalyst bed is separated from the reaction/mixing vessel for lignin extraction. A swirl jet is applied to the mixing vessel [102] to improve the mixing of biomass and solvents. A Computational Fluid Dynamic (CFD) model is established to predict the mixture's concentration distribution and flow dynamics in the mixing vessel [102]. CFD has evolved as an efficient and effective tool to get detailed insight into complex fluid flows (Kazemzadeh, A. et al. “A New Perspective in the Evaluation of the Mixing of Biopolymer Solutions with Different Coaxial Mixers Comprising of Two Dispersing Impellers and a Wall Scraping Anchor.” Chemical Engineering Research & Design, vol. 114, 2016, pp. 202-219 and Fathi Roudsari, S. et al. “Using a Novel CFD Model to Assess the Effect of Mixing Parameters on Emulsion Polymerization.” Macromolecular Reaction Engineering, vol. 10, no. 2, 2016, pp. 108-122). Some researchers have employed CFD to quantify the solid particle distribution in solid-liquid mixing of the stirred tank (Kee, N. C. S, and Tan, R. B. H. “CFD Simulation of Solids Suspension in Mixing Vessels.” Canadian Journal of Chemical Engineering, vol. 80, no. 4, 2002, pp. 721-726; Murthy, B. N. et al. “CFD Simulations of Gas-Liquid-Solid Stirred Reactor: Prediction of Critical Impeller Speed for Solid Suspension.” Chemical Engineering Science, vol. 62, no. 24, 2007, pp. 7184-7195; Srinivasa, T., and Jayanti, S. “An Eulerian/Lagrangian Study of Solid Suspension in Stirred Tanks.” AIChE Journal, vol. 53, no. 9, 2007, pp. 2461-2469; Panneerselvam, R. et al. “CFD Modeling of Gas-Liquid-Solid Mechanically Agitated Contactor.” Chemical Engineering Research & Design, vol. 86, no. 12, 2008, pp. 1331-1344; Micale, G, et al. “CFD Simulation of Particle Suspension Height in Stirred Vessels.” Chemical Engineering Research & Design, vol. 82, no. 9, 2004, pp. 1204-1213 and Ochieng, A., and Lewis, A. E. “CFD Simulation of Solids off-Bottom Suspension and Cloud Height.” Hydrometallurgy, vol. 82, no. 1, 2006, pp. 1-12). In this work, the fluid flow to solid suspension is modelled by the Eulerian and Eulerian (E-E) method (Megawati, T. B., Karwono, S. W., Musfiroh, R. “Scale-Up of Solid-Liquid Mixing Based on Constant Power/Volume and Equal Blend Time Using VisiMix Simulation.” MATEC Web Conf. 2018, 187, 04002), which has been validated in several published research articles. Moreover, the turbulence is modelled by the realizable k-ε model. This model is more suitable for swirling flow research than the standard k-ε model usually applied in the present stirred tank studies. Realizable k-ε models have substantial improvements in strong streamline curvature, vortices, and rotation flow features compared to the standard k-ε model.

The simulation result shows that the continuous flow reactor achieved uniform mixing. However, there is a small amount of dead zone with settled solid particles at the bottom of the mixing vessel [102] and a low concentration area at the inlet region of the swirl jet. The volume of the mixing vessel [102] with a homogeneous suspension still occupies more than 96% of the total volume. Moreover, this new mixing technology achieves 97% homogeneity. Besides, the simulation result shows the fluid flow structures and the recirculation of particles in the mixing vessel [102], demonstrating the dominant operating mechanism of swirling flow mixing technology.

### Mean Velocity Fields

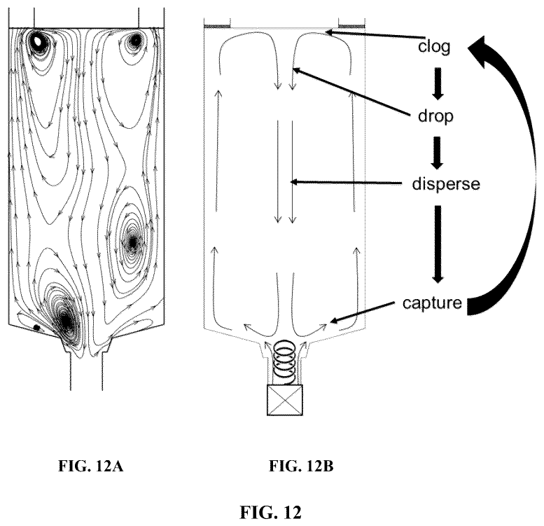

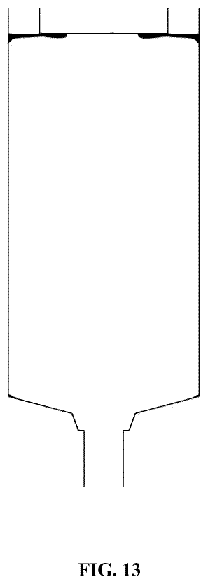

FIG. 12a shows the in-plane streamlines of the particles, which show the structure of the recirculation and transport of particles in the mixing vessel [102]. The particles move down from the middle of the mixing vessel [102] and up from the side, which forms a cycle of particles. A schematic representation of the recirculation of particles in the mixing vessel [102] is shown in FIG. 12b. The particle's movement follows the recirculation, up towards the filter [108] along the walls of the mixing vessel [102], and down in the central region of the mixing vessel [102]. The highly concentrated mixture detached from the top is dispersed by turbulence. This process requires that the outlet [106] is located along the edges of the upper base [107] and is more efficient with a filter [108]. On the one hand, the main flow from the outer side has less influence on the central region, thus creating a low-velocity zone in the middle and helping the particles move downward by gravity. On the other hand, the top recirculation has a velocity direction towards the center, which helps to bring the accumulated particles to the middle low-velocity zone and leaving the top side. After this, the dispersed particles are captured by the “Coanda-like flow” from the bottom and go up again. Due to the small recirculation between the cyclonic jet and the bottom surface, the jet is not close to the wall, which is not an actual Coanda flow. However, it plays the same role of avoiding and alleviating the bottom accumulation as a Coanda flow. This is demonstrated in the time-averaged particle concentration graph in FIG. 13. The black area in the cross-section is the area where the particle volume concentration is 40 vol % indicating a dense accumulation. There is almost no dense accumulation of particles at the bottom of the mixing vessel [102] and only a small amount of dense accumulation at the sides.

### Utilization of Volume

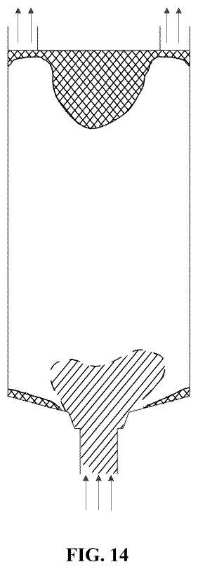

In this example, swirling flow mixing technology was applied in the RCF chemical reactor to facilitate the mixing of biomass particles and solvents. In chemical reactors, the utilisation of the volume of the mixing vessel [102] is an important parameter. Due to the mechanism of particle recirculation in a swirling flow mixing scheme, a certain volume of a high particle concentration will exist at the top of the mixing vessel [102]. On the other hand, there is a low concentration zone in the inlet area of the swirl jet. Too high or too low particle concentrations are detrimental to the reaction, and the volume of these areas is not ideally suited to the application. In this case, the average particle concentration in the mixing vessel [102] is 20 vol % and the volume with the appropriate particle concentration is determined to be plus or minus 5 vol %, i.e 15-25 vol %. As shown in FIG. 14, the grid-filled area is the area of particle accumulation at concentrations greater than 25 vol %, while the dashed-filled area is the area of low concentration near the swirl jet inlet. The blank area in the diagram shows the volume of particles with a concentration of 15-25 vol % that can be effectively used, which occupies most of the mixing vessel [102]. The effective utilization of the mixing vessel [102] is 96.3%.

### Homogeneity

In order to determine the degree of uniformity of the particle distribution in the mixing vessel [102], the criterium of homogeneity is used here. The extent of homogeneity was calculated using the following equation (Hosseini, S. et al. “Study of Solid-Liquid Mixing in Agitated Tanks through Electrical Resistance Tomography.” Chemical Engineering Science, vol. 65, no. 4, 2010, pp. 1374-1384):

$$Homogeneity = 1 - \sqrt{\frac{{\sum }_{1}^{q} {( {X}_{v} - \overline{{X}_{v}} )}^{2}}{q}} ,$$

where Xᵥ, X̅ᵥ̅, and q are the solid volume fraction on a given section, the averaged solid volume fraction inside the mixing vessel [102] and the number of planes. As shown in the equation, homogeneity is a criterion for sampling several sections, and the section perpendicular to the mixing vessel [102]'s central axis is generally chosen. Here 11 equidistant parallel sections are selected as samples through the axis.

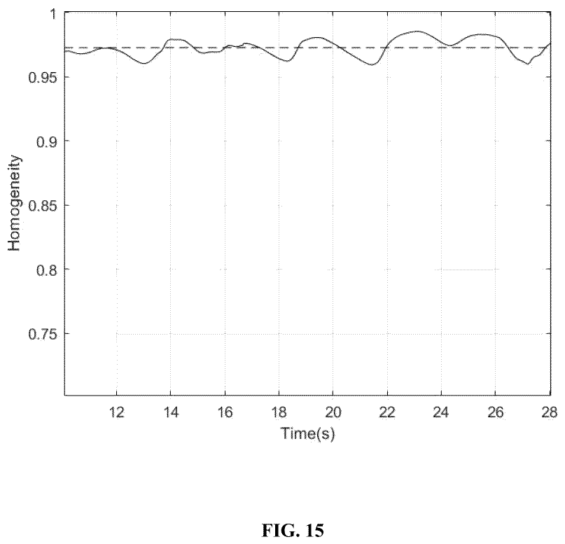

FIG. 15 shows the homogeneity in the mixing vessel [102] within 18 seconds after the simulation has been relatively stable. Its average homogeneity is 0.97. Here, the homogeneity shows some fluctuations with a range of variation of 1.3%. This is because the accumulation and detachment of particles at the top filter [108] are not continuous. Homogeneity is lower when more particles accumulate at the filter [108] and is higher when the accumulated particles fall by gravity and are dispersed by the swirl flow in the lower region of the mixing vessel [102]. This results in a certain amount of non-uniform particle distribution in the transient. However, as shown in FIG. 15 the mixing vessel [102] mixing performance maintained a high homogeneity even with the worst particle distribution, and an average homogeneity equal to 0.975 is a good mixing compared to stirred tanks.

### Draft Tube

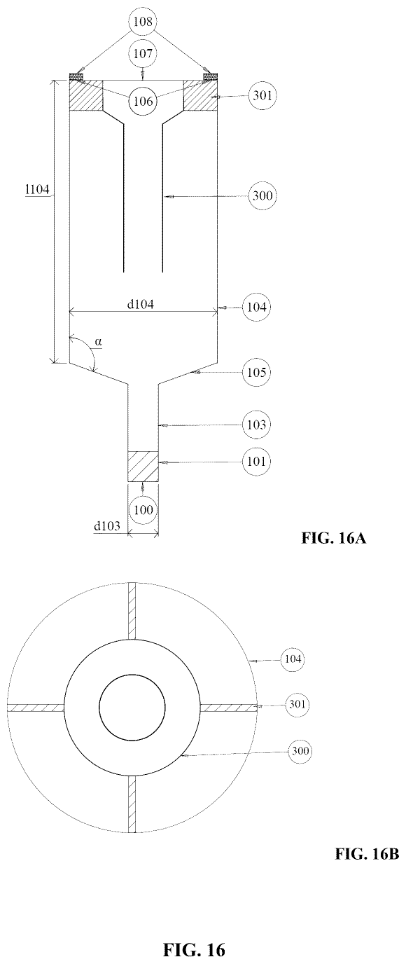

One option to further improve this mixing technology is to add a draft tube to the vessel, as shown in FIGS. 16a-b, which consists of a draft tube [300] and its support [301]. Adding the draft tube [300] reduces the effect of centrifugal forces on the downward particle suspensions in the center of the vessel. At the same time, the low-pressure zone, created by the downward flow in the draft tube, also helps the particles to sink in front of the filter, which reduces the stress on the filter. For the draft tube, the structure, location and installation are not strict, but the presence of a tubular structure in the vessel that physically separates the central downward flow of particle suspension from the outer upward flow is the essential aspect of this improved option. The example shown in FIG. 16 uses a funnel structure draft tube [300] connected to the upper cylindrical part of the mixing vessel [104] or to the upper base of the mixing vessel [107] by four plate-like supports. With this configuration of the draft tube, the homogeneity in the mixing tank can be increased to 0.994.

### CONCLUSIONS

In this example, a design for a scalable continuous flow reactor for high temperature and pressure is tested. The computational fluid dynamics (CFD) modelling was employed to explore the mixing quality for the swirling flow solid-liquid mixing operations with Reynolds number Re=130000 and swirl number Sw=1.2. The validity of the Eulerian-Eulerian two-phase model and realizable k-ε turbulence model in the study of solid-liquid mixing problems has been proven in a number of publications, and simulation can provide convincing results. From the simulations, it was observed that the swirling flow mixing technique, in this case, achieved an average of 97.3% homogeneity and 96.3% volume utilization. At the same time, the time-averaged particle streamlines explain the dominant flow cycle of the particles in the mixing vessel [102]. This new swirling flow-based solid-liquid mixing technology therefore provides unexpected performance.

### LIST OF REFERENCES USED

[100] inlet
[101] swirl generator
[102] mixing vessel
[103] lower cylindrical part of the mixing vessel [102]
[d103] diameter of the lower cylindrical part of the mixing vessel [102]
[104] upper cylindrical part of the mixing vessel [102]
[d104] diameter of the upper cylindrical part of the mixing vessel [102]
[l104] length of the upper cylindrical part of the mixing vessel [102]
[105] tapered part of the mixing vessel [102]
[106] outlet
[107] upper base of the mixing vessel [102]
[107a] central part of the upper base of the mixing vessel [107]
[r107a] radius of the central part of the upper base of the mixing vessel [107a]
[108] filter
[200] nozzle
[201] first nozzle part
[w201] projected width of the first nozzle part [201] on the horizontal axis
[202] second nozzle part
[h202] projected height if the second nozzle part [202] on the vertical axis
[300] draft tube
[301] support for draft tube

1.-15. (canceled)

16. A continuous flow reactor comprising:
an inlet;
a swirl generator, downstream of, and in fluid communication with, the inlet; and,
a mixing vessel comprising,
(i) a lower cylindrical part in direct fluid communication with the outlet of the swirl generator;
(ii) an upper cylindrical part of diameter larger than the diameter of the lower cylindrical part;
(iii) a tapered part located between the lower cylindrical part and the upper cylindrical part, wherein the wall of the tapered part forms an angle α, measured inside the mixing vessel, with the wall of the upper cylindrical part superior to 90 degrees and inferior to 180 degrees; and,
(iv) an outlet located on the upper base of the upper cylindrical part and outside of the central part of said upper base, wherein said central part is a circle, concentric with the upper base, and with a radius of 25% of the radius of the upper base, and
wherein a swirl number that the swirl generator is adapted to provide, and the dimensions of the mixing vessel, are adapted to generate a Coanda flow of liquid, along the wall of the tapered part and the wall of the upper cylindrical part, when liquid is flowing through the reactor.

17. The continuous flow reactor according to claim 16, wherein said mixing vessel further comprises between the lower cylindrical part and the tapered part, a nozzle comprising a first nozzle part,
wherein the angle β, measured outside of the mixing vessel, between the wall of the lower cylindrical part and the wall of the first nozzle part is superior or equal to 90 degrees and inferior to 180 degrees.

18. The continuous flow reactor according to claim 17, wherein the projected width of the first nozzle part is inferior or equal to 79% of the diameter of the lower cylindrical part.

19. The continuous flow reactor according to claim 17, wherein said nozzle further comprises a second nozzle part between the first nozzle part and the tapered part, wherein the angle γ between the wall of the second nozzle part and the vertical axis of the mixing vessel is superior or equal to 0 degrees and inferior or equal to 90 degrees.

20. The continuous flow reactor according to claim 19, wherein the projected height of the second nozzle part is inferior to 85% of the diameter of the lower cylindrical part.

21. The continuous flow reactor according to claim 16, wherein said outlet is located along the edge of the upper base.

22. The continuous flow reactor according to claim 16, wherein said outlet is an annular outlet concentric with the upper base.

23. The continuous flow reactor according to claim 16, wherein said outlet comprises a filter.

24. The continuous flow reactor according to claim 16, wherein said continuous flow reactor is for mixing solid particles in a liquid.

25. The continuous flow reactor according to claim 16, wherein the angle α is superior or equal to 95 degrees.

26. The continuous flow reactor according to claim 16, wherein the swirl generator is configured to generate a swirling flow of liquid in the lower cylindrical part.

27. The continuous flow reactor according to claim 16, wherein the mixing vessel further comprises a central draft tube, configured to separate the central downward flow of liquid from the outer upward flow of liquid when liquid is flowing through the reactor.

28. The continuous flow reactor according to claim 16, wherein the diameter of the upper cylindrical part ranges from 270% to 670% of the diameter of the lower cylindrical part.

29. The continuous flow reactor according to claim 16, wherein the length of the upper cylindrical part is inferior or equal to 2200% of the diameter of the lower cylindrical part.

30. A method of mixing and/or reacting solid particles with a liquid comprising the steps of:
(a) placing said solid particles in the mixing vessel of the continuous flow reactor according to claim 16, and,
(b) circulating said liquid through the continuous flow reactor.
